(19) United States
(12) Patent Application Publication
(10) Pub. No.: US 2011/0105968 A1
(43) Pub. Date: May 5, 2011

(54) Massager

(76) Inventors: Denise Susanna Angell, Calgary (CA); Albert Earle Broadfoot, Calgary (CA)

(21) Appl. No.: 12/588,860

(22) Filed: Oct. 30, 2009

(51) Int. Cl. A61H 15/00

(52) U.S. Cl. 601/132

(57) ABSTRACT

Disclosed is an apparatus for massaging a body part of a user comprising an elongate member having first and second ends and at least one pliable body located along the elongate member. The apparatus further comprises a fastener secured to the first end for suspending the elongate member therefrom between the back of the user and the seating surface of a user's seat back so as to massage the back of the user.

### BACKGROUND OF THE INVENTION

1. Field of Invention

The present invention relates to massagers in general and in particular to an apparatus for massaging a body part of a user.

2. Description of Related Art

It is well known that many people suffer from back pain and stiffness. For such individuals, medications to relieve pain or relax muscles are commonly utilized, to seek relief from such pain and stiffness. However, such medications are typically temporary and only mask or otherwise disguise the pain. In these cases, the pain often returns after the medication wears off. In addition, these medications can have other side effects such as drowsiness which are inadvisable for people who are operating equipment such as vehicles.

Another treatment for back pain and stiffness is massage which is a commonly applied by a professional. Such professionals are expensive and require time consuming appointments to receive the benefits of such treatment. These appointments are often not practical.

Previous devices have attempted to provided back massagers for use in a vehicle. However such devices have typically engaged the entire back, such as for example, in the form of a beaded seat cover. These devices are not therefore able to selectably massage a specific point on the back of a user. These devices are also not adapted to be utilized in other settings such as a household chair, hot tub or any other seating location desired by the user.

### SUMMARY OF THE INVENTION

According to a first embodiment of the present invention there is disclosed an apparatus for massaging a body part of a user comprising an elongate member having first and second ends and at least one pliable body located along the elongate member. The apparatus further comprises a fastener secured to the first end for suspending the elongate member therefrom between the back of the user and the seating surface of a user's seat back so as to massage the back of the user.

The pliable bodies may comprise spheres. The spheres may be formed of rubber. The apparatus may comprise a plurality of pliable bodies. The apparatus may comprise two pliable bodies. The pliable bodies may include bores therethrough for passing the elongate member. The apparatus may further comprise support members for supporting the pliable bodies on the elongate member. The apparatus may include a support member for each pliable body. The support member may comprise a body having a bore therethrough sized to pass the elongate body wherein the support member is selectably lockable to the elongate body to fix the support member thereto. The support member may comprises a cord lock.

The elongate member may have a circular cross-section. The elongate member may comprise a string. The second end of the elongate member may includes an end stop sized to prevent the pliable body from moving therepast.

The fastener may comprise a hook. The fastener may comprise a carabiner. The fastener may comprise a suction cup for securing to a flat surface. The apparatus may further include a plurality of pliable bodies located at opposed ends of the elongate member wherein the elongate member includes a u-shaped portion therebetween. The fastener may comprise a coupler adapted to span the u-shaped portion and retain the seating surface therein.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a massage apparatus according to a first embodiment of the present invention applied to a vehicle seat back.

FIG. 2 is an exploded view of the massage apparatus of FIG. 1.

FIG. 3 is a perspective view of a massage apparatus according to a further embodiment of the present invention applied to a seat of a hot tub.

FIG. 4 is a perspective view of a massage apparatus according to a further embodiment of the present invention having a loop type fastener.

### DETAILED DESCRIPTION

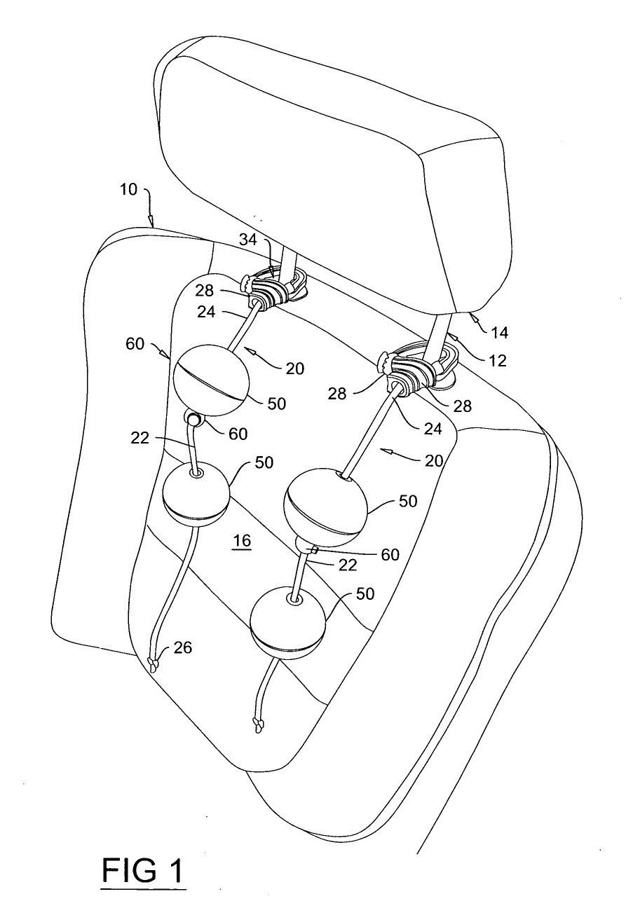

Referring to FIGS. 1 through 3, an apparatus according to a first embodiment of the invention is shown generally at 20 as applied to a vehicle seat 10. As illustrated, the apparatus 20 is secured to and suspended from the posts 12 of a vehicle headrest 14 such that the apparatus 20 lies against the front surface 16 of the seat 10.

The apparatus 20 comprises a flexible elongate member 22 having first and second ends, 24 and 26, respectively. The apparatus 20 includes at least one pliable body 50 mounted along the elongate member supported by a support member 60.

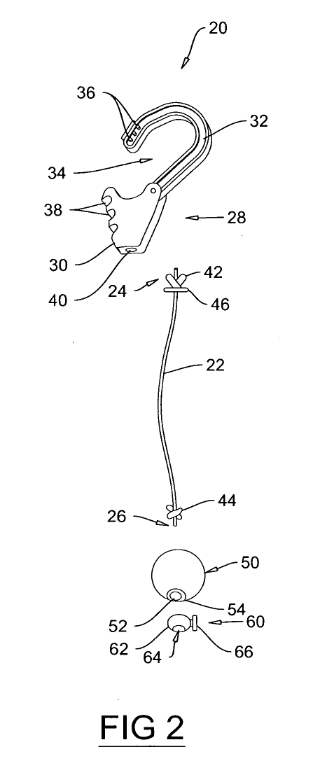

The first end 24 of the elongate member 22 includes an attachment device for suspending the apparatus 10. As illustrated in FIG. 1, the attachment device may be have a hook, carabiner 28 or the like. The carabiner 28 includes a fixed portion 30 and a rotatable portion 32 rotatably secured thereto. The rotatable portion 32 may be selectably rotated into engagement with the fixed portion so as to form a continuous loop 34 therewith as illustrated in FIG. 1 or away from the fixed portion 30 into an open position as illustrated in FIG. 2. As illustrated, the rotatable portion 32 may include at least one post 36 engagable with one of a plurality of corresponding notches 38 on the fixed portion 30. It will be appreciated that other closure types as are conventionally known in the art may also be utilized for retaining the fixed and rotatable portions together. In operation, the rotatable portion 32 may be opened to the open position and located around the post 12 of the seat headrest 14. Thereafter, the rotatable portion 32 may be rotated into engagement with the fixed portion 30 as illustrated in FIG. 1 such that the post 12 is contained within the loop 34. As illustrated in FIG. 1, the fixed portion 30 may also include a bore 40 sized to pass the elongate member 22 therethrough.

The elongate member 22 may comprise any flexible elongate tensile member. As illustrated, the elongate member 22 may be formed of a length of cord, string, rope or the like. The elongate member 22 may have an suitable cross section as desired by the user, such as, by way of non-limiting example, circular, oval or rectangular. It will also be appreciated that other flexible members may be utilized. It will also be appreciated that the flexible member may have some elasticity to permit lengthening of the apparatus 20 in some embodiments. The elongate member 22 includes a top knot 42 at the first end 24 and a bottom knot 44 at the second end. The elongate member 22 may also include a washer 46 or other suitable load distributing means proximate to the top knot 42. The bore 40 in the fixed portion 30 is sized to pass the elongate member 22 therethrough. The washer 46 and/or top knot 42 are sized so as to prevent their passing through the bore 40. Therefore, the washer 46 and or top knot 42 prevent the elongate member from being removed from the bore 40 so as to suspend the elongate member 22 therefrom. Similarly, the bottom knot 44 is sized to as to prevent the pliable bodies 50 and support members 60 from being moved therepast so as to retain the pliable bodies 50 and support members 60 on the elongate member 22.

The pliable bodies 50 as illustrated in the accompanying Figures comprise spherical balls having central bores 52 therethrough. Each central bore 52 is sized to slidably receive the elongate member 22 therein. The central bore may include a bushing insert 54 or the like to assist the pliable body 50 to move freely on the elongate member 22. The central bore 52 may also include a sleeve therethrough so as to facilitate movement of the pliable bodies on the elongate member 22. The sleeve may be formed of plastic, metal or any other relatively low friction surface. As illustrated in FIG. 2, the apparatus 20 may include one pliable body 50. Optionally, the apparatus 20 may include more than one pliable body 50 as illustrated in FIG. 1. Although the pliable body 50 is illustrated as a sphere in the accompanying Figures, it will be appreciated that other shapes may be utilized as well, such as by way of non-limiting example, polyhedron, conical, ellipsoid or a non-regular shaped body. The pliable body 50 may be formed of any pliable material such as plastics, natural and synthetic rubbers and elastomers, rubber impregnated fabrics, and natural and synthetic leathers.

The support member 60 comprises a body 62 having a central bore 64 therethrough sized to accept the elongate member 22. The central bore 64 is selectably securable to the elongate body 22. In some embodiments, the support member may comprise a cord lock or cord fastener. In such embodiments, the support member includes a toggle or plunger 66 and an internal spring (not shown). The toggle 66 extends into the body 62 and includes a bore having a similar dimension to the central bore 64. The spring biases the bore in the toggle out of alignment with the central bore 64 such that the two bores may be substantially aligned when a user depressed the toggle. In such an alignment, the elongate member 22 may be freely passed therethrough and the support member 60 repositioned on the elongate member. Thereafter, the user may release the toggle so the spring will bias the toggle bore out of alignment with the central bore thereby frictionally engaging the elongate member 22 therebetween. In such a position, the support member will be secured on the elongate member. As shown in FIG. 2, the apparatus 20 may include one support member 60 located below the pliable body 50. Optionally, the apparatus 20 may include more than one support member 60 wherein each support member supports a pliable body 50 thereby permitting each pliable body to be moved independently of each other.

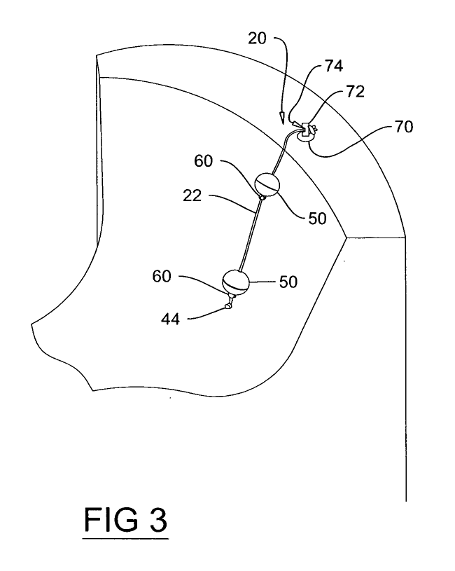

Turning not to FIG. 3, The attachment device may also comprise a suction cup 70 as illustrated in FIG. 3 for attachment to a flat surface such as, by way of non-limiting example, the surface of a hot tub. The suction cup 70 may include an upright body 72 having a bore 74 therethrough for receiving and retaining the elongate member 22 as described above. It will be appreciated that other attachment devices may also be utilized.

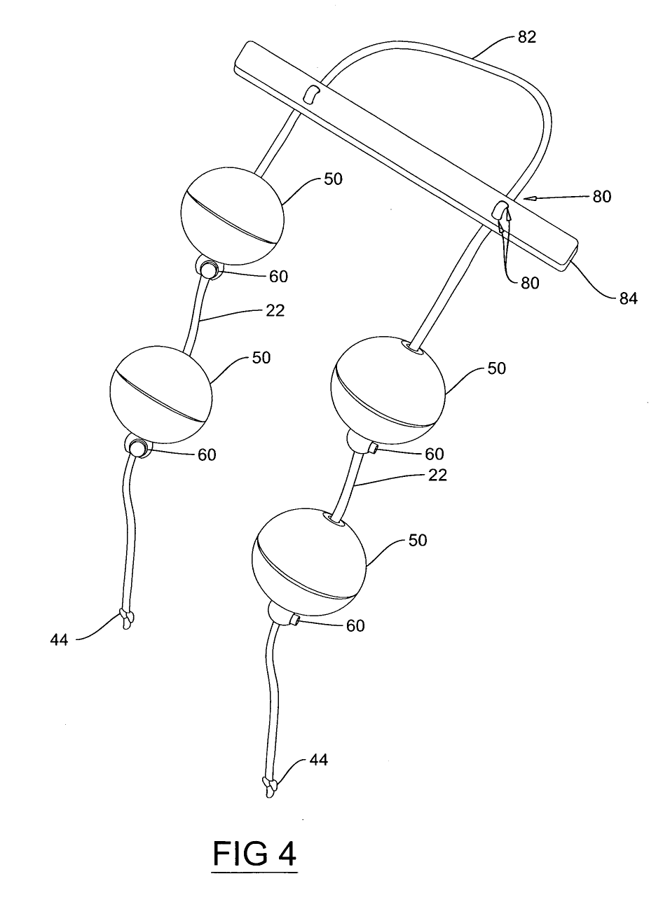

With reference to FIG. 4, a further embodiment is illustrated having a loop type fastener 80 suspending a pair or elongate members 22 therefrom. As illustrated, the loop fastener may comprise a longer section of the elongate member 22 such that the apparatus includes two sets of pliable bodies 50 suspended on opposed ends of the elongate fastener with a u-shaped portion 82 therebetween. The loop fastener 80 may include a slide bar 84 sized to span the u-shaped portion 82. The slide bar may include one or more bores 86 therethrough to receive the elongate member such that the elongate member 22 may be frictionally slidably moved through the bores 86 so as to reposition the slide bar. In operation, the headrest 14 may be located within the u-shaped portion 82 and the slide bar 84 tightened up against the headrest so as to secure the apparatus thereon.

In operation, the apparatus 20 may be located against the front surface 16 of a seat 18 of a vehicle. Thereafter, a user may sit on the seat 18 such that the pliable bodies 50 massage particular locations on the back of the user. The user may move the pliable bodies 50 on the elongate member by repositioning the support members 60 as described above to cause the pliable bodies 50 to massage different locations on their back. The user may employ one or more of the apparatuses as illustrated in FIG. 1 as desired. In addition, it will be appreciated that due to the turning motion of the vehicle around corners, the pliable bodies 50 will roll across the back of the user so as to move the massaged point around on their back. Additionally the, vibration of the vehicle will be transmitted through the present apparatus to assist in massaging the user. The apparatus 20 may be applied to a wide variety of seating surfaces, such as, by way of non-limiting example, car seats, kitchen tables, recliners, hot tubs or the like. Additionally, when applied to a hot tub or whirlpool, the motion of the water around the user will also move and vibrate the pliable bodies so as to assist in massaging the user.

While specific embodiments of the invention have been described and illustrated, such embodiments should be considered illustrative of the invention only and not as limiting the invention as construed in accordance with the accompanying claims.

What is claimed is:

1. An apparatus for massaging a body part of a user comprising;
a flexible elongate member having first and second ends;
at least one pliable body located along said elongate member; and
a fastener selectably secured to said first end for suspending said elongate member therefrom between the back of the user and the seating surface of a user's seat back so as to massage the back of the user.

2. The apparatus of claim 1 wherein said at least one pliable body comprise spheres.

3. The apparatus of claim 2 wherein said spheres are formed of rubber.

4. The apparatus of claim 1 further comprising a plurality of pliable bodies.

5. The apparatus of claim 4 further comprising two pliable bodies.

6. The apparatus of claim 1 wherein said pliable bodies include bores therethrough for passing said elongate member.

7. The apparatus of claim 1 further comprising support members for supporting said pliable bodies on said elongate member.

8. The apparatus of claim 7 further comprising a support member for each pliable body.

9. The apparatus of claim 8 wherein said support member comprises body having a bore therethrough sized to pass said elongate member, said support member being selectably lockable to said elongate member to fix said support member thereto.

10. The apparatus of claim 9 wherein said support member comprises a cord lock.

11. The apparatus of claim 1 where said elongate member has a circular cross-section.

12. The apparatus of claim 11 wherein said elongate member comprises a cord.

13. The apparatus of claim 1 wherein said second end of said elongate member includes and end stop sized to prevent said pliable body from moving therepast.

14. The apparatus of claim 1 wherein said fastener comprises a hook.

15. The apparatus of claim 1 wherein said fastener comprises a carabiner.

16. The apparatus of claim 1 wherein said fastener comprises a suction cup for securing to a flat surface.

17. The apparatus of claim 1 further including a plurality of pliable bodies located at opposed ends of said wherein said elongate member includes a u-shaped portion therebetween.

18. The apparatus of claim 17 wherein said fastener comprises a coupler adapted to span said u-shaped portion and retain said seating surface therein.
